(19) United States
(12) Patent Application Publication
(10) Pub. No.: US 2008/0313739 A1
(43) Pub. Date: Dec. 18, 2008

(54) System Test and Evaluation Automation Modules

(75) Inventor: Charles Edward Martin, Virginia Beach, VA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/761,775

(22) Filed: Jun. 12, 2007

(51) Int. Cl. G06F 15/18

(52) U.S. Cl. 726/25

(57) ABSTRACT

Methods are provided for providing uniform and repeatable information security (INFOSEC) assessments. In the embodiments, a security assessor interacts with a system test evaluation and automation module (S.T.E.A.M.) to perform an INFOSEC assessment on a computer system. S.T.E.A.M. generates reports and checklists to help determine whether the computer system being assessed is compliant with one or more INFOSEC requirements. Additionally, S.T.E.A.M. generates reports and checklists that assist the INFOSEC assessor in determining the most important, and most vulnerable data on the computer system.

### FIELD OF THE INVENTION

The present invention relates to assessing the information and security (INFOSEC) of a computer system and, more particularly, to assessing compliance with INFOSEC laws, standards, and regulations.

### DESCRIPTION OF RELATED ART

Computer systems often contain sensitive information, and communicate that information to other computer systems. The information can range from an individual's credit card number and social security number to classified national security information, among other things. As more sensitive information is stored on, and communicated between, computer systems, more attempts are made by hackers to break into these systems, in order to obtain or corrupt the information, among other purposes.

In order to combat hackers (among other reasons), governments and standards organizations have promulgated numerous INFOSEC rules and regulations. For example, the United States Department of Defense (DoD) Instruction 8500.2 includes various requirements for securing a DoD information system. The Health Insurance Portability and Accountability Act (HIPAA) includes various security requirements related to conducting electronic healthcare transactions, maintaining patient information, along with numerous other provisions. The National Institute of Standards and Technology (NIST) Special Publication 800-53 and 800-53(a) are guidelines for selecting and specifying security controls for information systems supporting the executive agencies of the federal government. The Gramm-Leach-Bliley Act (GLBA) includes requirements for protecting private financial information collected by financial institutions. Numerous other legislative acts pertaining to INFOSEC exist as well.

Also, various organizations have published various guidelines for systems administrators to follow when designing computer systems, and for security auditors to use when performing an INFOSEC assessment of an existing system. For example, International Standards Organization (“ISO”) ISO-17799 and the National Security Agency (NSA) INFOSEC Assessment Methodology (IAM) and INFOSEC Evaluation Methodology (IEM) involve (1) gathering information about a system, (2) identifying various data types on a system, (3) evaluating the importance of each data type's confidentiality, integrity, and availability (together, CIA), and (4) determining what changes need to be made to lower a system's security risk to an acceptable level of risk.

Thus, if a system administrator is performing an INFOSEC assessment for a system that maintains healthcare records, the administrator may decide that the confidentiality and integrity of the information is more important than the availability of the information. First, individuals do not want their health records to be released to people who should not have access to those records. Second, if individuals' health records are not accurate, they may not receive appropriate treatment for their ailments.

Unfortunately, in spite of these rules, regulations, standards, and guidelines (together, “requirements”), INFOSEC assessments are difficult to perform and often produce inconsistent results. This is because (1) there are numerous laws governing INFOSEC, and those laws often change, (2) creating checklists necessary to perform an INFOSEC assessment is extremely time consuming and tedious, (3) there is a lack of uniformity and repeatability across multiple INFOSEC assessment types and teams. Therefore, improvements are desired.

### SUMMARY OF THE INVENTION

Methods are provided for providing uniform and repeatable INFOSEC assessments. In the embodiments, a security assessor interacts with a system test evaluation and automation module (“S.T.E.A.M.”) to perform an INFOSEC assessment on a computer system, single application, group of software applications, and/or a stand alone computer or a network (collectively, “computer system”). S.T.E.A.M. generates reports and checklists to help determine whether the computer system being assessed is compliant with one or more INFOSEC requirements. Additionally, S.T.E.A.M. generates reports and checklists that assist the INFOSEC assessor in determining the most important, and most vulnerable data on the computer system.

S.T.E.A.M. generates checklists and reports describing whether the assessed computer system is susceptible to one or more INFOSEC vulnerabilities. S.T.E.A.M. indicates which elements of the computer system are the most vulnerable. This assists the computer system's administrator in prioritizing when and where to implement changes to the computer system.

These as well as other aspects and advantages will become apparent to those of ordinary skill in the art by reading the following detailed description, with reference where appropriate to the accompanying drawings.

### BRIEF DESCRIPTION OF THE DRAWINGS

FIG. 1 is a block diagram depicting an INFOSEC assessor conducting an assessment on a computer system.

FIG. 2 is a block diagram depicting an example of how INFOSEC requirements may be stored in a database.

FIG. 3 is a flow chart depicting an INFOSEC assessment to determine compliance with a specific INFOSEC requirement.

FIG. 4 is a flow chart depicting an INFOSEC assessment to determine compliance with a specific INFOSEC requirement.

FIG. 5 is a flow chart depicting an INFOSEC evaluation to determine compliance with a specific INFOSEC requirement.

FIG. 6 is an example of a data type weight worksheet.

FIG. 7 is an example of a findings worksheet.

FIG. 8 is an example of an overall vulnerability criticality matrix.

### DETAILED DESCRIPTION

### 1. Overview

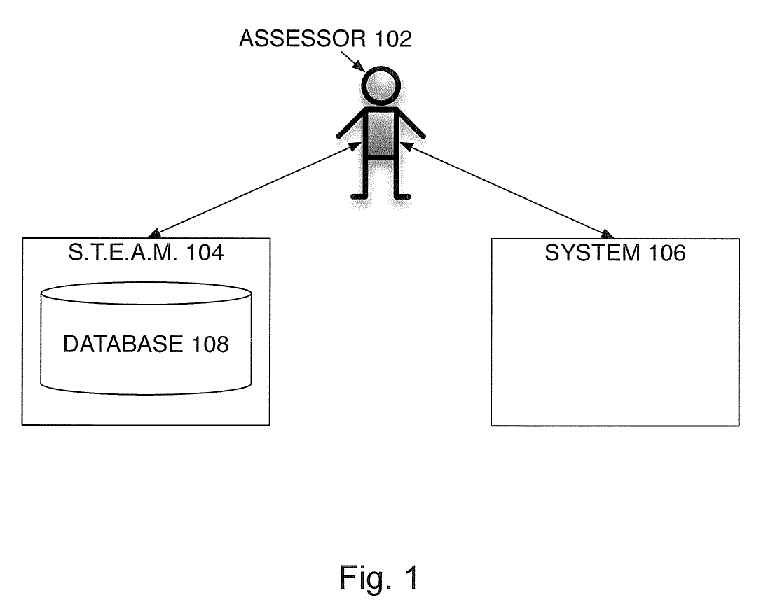

The present systems and methods allow a security assessor to perform consistent and reliable INFOSEC assessments. Specifically, as shown in FIG. 1, security assessor 102 interacts with a system test evaluation and automation module (“S.T.E.A.M.”) 104 to perform an INFOSEC assessment. S.T.E.A.M. 104 includes a database 108 that stores (1) various INFOSEC requirements, and (2) information related to each INFOSEC assessment. Assessor 102 inputs information into S.T.E.A.M. 104. It should be understood that “input” may refer to selection, entering one value, entering multiple values, or associating values. In response to assessor 102's inputs, S.T.E.A.M. 104 generates a survey for assessor 102 to use in assessing the security of a computer system 106. After completing the survey, assessor 102 inputs the results of the survey into the S.T.E.A.M. 104, which then generates a report describing whether system 106 is in compliance with one or more specific INFOSEC requirements stored in database 108. If system 106 is not in compliance, the report highlights the system's specific failings. This allows the administrator of system 106 to quickly modify system 106 so it is compliant.

Performing assessments in such a manner is desirable because it enables quick, accurate, and consistent security assessments.

### 2. Entering INFOSEC Requirements into a Database

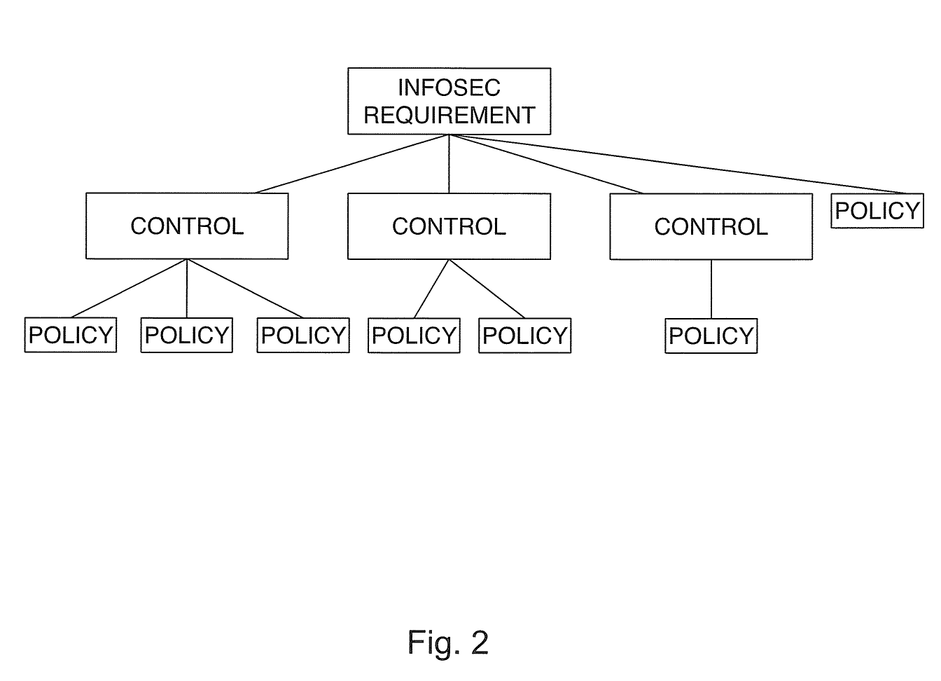

In order to ensure that a computer system complies with one or more specific INFOSEC requirements, the INFOSEC requirements must first be encoded into a database. As shown in FIG. 2, encoding a specific requirement into the database involves breaking the requirement into component controls, and breaking those controls into component policies. A control is a subset of an INFOSEC requirement. For example, if the INFOSEC requirement is directed to computer security, one control may be “identification and authentication” while another control may be “design and configuration.” A policy is a single system characteristic that assessor 102 can assess. For example, if the INFOSEC requirement is directed to computer security, policies of the requirement may include the length of computer password, types of characters used in the password, and how often the password is changed.

If the INFOSEC requirement is simple enough such that it only contains a single control, the INFOSEC requirement need only be broken down into component policies. Additionally, if the INFOSEC requirement is complex, each control may be broken down into one or more sub-controls, and those sub-controls can be broken down into policies.

For example, under DoD instruction 8500.2, a computer system is required to follow certain security policies based on what are known as (1) the system's mission assurance category (MAC), and (2) the system's confidentiality level.

A system can have one of three MAC levels. Each MAC level is dependent on the importance of information being stored on the computer system. For example, a “MAC I” system contains vital information and requires significant protection measures, while “MAC III” systems are less important, and therefore only require protective measures commensurate with commercial best practices.

A system's confidentiality level is dependent on the nature of information processed by the system. Under DoD 8500.2, information is categorized as “classified,” “sensitive,” or “public.”

DoD 8500.2 provides a set of controls for each MAC and confidentiality level. For example, {MAC I-III, sensitive} systems are required to implement a control called “individual identification and authentication” (“IAIA-1”), which states:
DoD information system access is gained through the presentation of an individual identifier (e.g., a unique token or user login ID) and password. For systems utilizing a logon ID as the individual identifier, passwords are, at a minimum, a case sensitive 8-character mix of upper case letters, lower case letters, numbers, and special characters, including at least one of each (e.g., emPagd2!). At least four characters must be changed when a new password is created. Deployed/tactical systems with limited data input capabilities implement the password to the extent possible. Registration to receive a user ID and password includes authorization by a supervisor, and is done in person before a designated registration authority. Additionally, to the extent system capabilities permit, system mechanisms are implemented to enforce automatic expiration of passwords and to prevent password reuse. All factory set, default or standard-user IDs and passwords are removed or changed. Authenticators are protected commensurate with the classification or sensitivity of the information accessed; they are not shared; and they are not embedded in access scripts or stored on function keys. Passwords are encrypted both for storage and for transmission.
This control can be broken down into the following 12 policies:
1. DoD information system access is gained through the presentation of an individual identifier (e.g., a unique token or user login ID) and password.
2. For systems utilizing a logon ID as the individual identifier, passwords are, at a minimum, a case sensitive 8-character mix of upper case letters, lower case letters, numbers, and special characters, including at least one of each (e.g., emPagd2!).
3. At least four characters must be changed when a new password is created.
4. Deployed/tactical systems with limited data input capabilities implement the password to the extent possible.
5. Registration to receive a user ID and password includes authorization by a supervisor.
6. Registration to receive a user ID and password is done in person before a designated registration authority.
7. To the extent system capabilities permit, system mechanisms are implemented to enforce automatic expiration of passwords and to prevent password reuse.
8. All factory set, default or standard-user IDs and passwords are removed or changed.
9. Authenticators are protected commensurate with the classification or sensitivity of the information accessed;
10. Authenticators are not shared;
11. Authenticators are not embedded in access scripts or stored on function keys.
12. Passwords are encrypted both for storage and for transmission.

After breaking down the control, each policy can be entered into the database, and associated with control IAIA-1. Control IAIA-1, in turn, is associated with {MAC I-III, sensitive} systems.

It should be understood that there are many other INFOSEC requirements that can be entered into the system beyond DoD 8500.2. HIPAA, GLBA, NIST 800-53, NIST 800-53(a), NSA-IAM, NSA-IEM, and ISO-17799 are just a few examples of other laws, guidelines, and regulations that can be used. It should further be understood that other INFOSEC guidelines may be entered into the database as well. Additionally, as new rules, regulations, and guidelines are implemented, they may also be entered into the database.

### 3. Exemplary Security Assessment

a. Compliance with Rules and Regulations

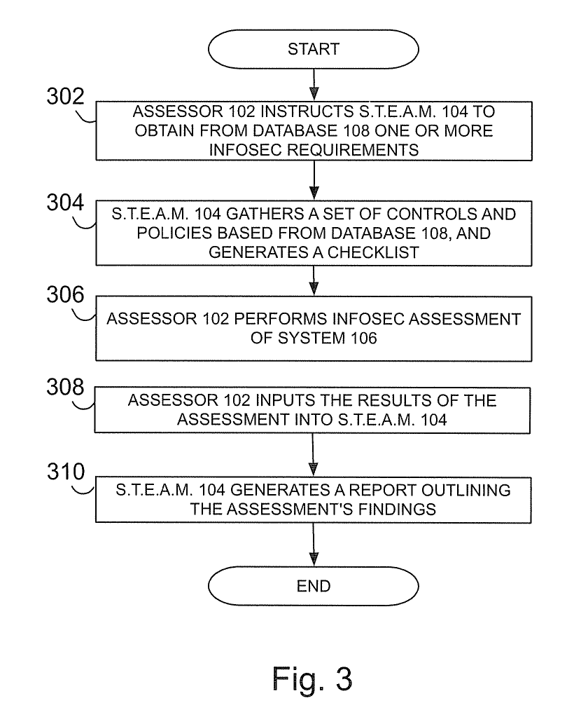

FIG. 3 is a flow chart depicting an INFOSEC assessment of a corporation's computer system. Specifically, FIG. 3 depicts an assessment to determine whether the system is compliant with DoD instruction 8500.2.

As shown in FIG. 3, at step 302, assessor 102 instructs S.T.E.A.M. 104 to obtain, from database 108, the INFOSEC requirement (or requirements) being used to assess system 106. In this case, assessor 102 selects DoD 8500.2. Next, assessor 102 indicates system 106's MAC (i.e., I, II, or III) and confidentiality level (i.e., classified, sensitive, or public).

At step 304, S.T.E.A.M. 104 gathers from database 108 a list of controls and policies for system 106's MAC and confidentiality level, and generates a checklist for assessor 102 to use to determine whether the computer system is in compliance. The checklist includes a list of controls and policies needed to ensure compliance with DoD 8500.2. Additionally, the checklist includes checkboxes that indicate whether or not the policy (1) was observed, (2) was not found, (3) was not reviewed, or (4) was not applicable. The checklist may be organized by control, and may have each policy listed for each control.

At this point, assessor 102 may decide to divide system 106 into one or more sub-systems. For example, system 106 may include separate email systems and accounting systems, and assessor 102 may decide to perform a separate assessment on each sub-situation. In such a situation, assessor 102 may instruct S.T.E.A.M. 104 to include duplicate controls and policies in the checklist. This enables assessor 102 to perform separate tests on each sub-system.

Next, at step 306, assessor 102 uses the checklist to determine whether system 106 is in compliance with DoD instruction 8500.2. Assessor 102 may print one or more copies of the checklist, and distribute copies of the checklist to members of his or her team. The assessment team members then use the checklist to test whether the system 106 is in compliance with the DoD instruction 8500.2. There are several ways team members may obtain the information. Among other ways, the assessment team could interview people who have knowledge of system 106. Additionally, the assessment team could perform tests on system 106 directly.

At step 308, assessor 102 inputs the results of the tests, called “findings,” into S.T.E.A.M. 104. For each policy, assessor 102 indicates whether the policy was observed, not found, not reviewed, or not applicable. A finding of “not found” could mean that system 106 did not satisfy the policy, or that assessor 102 was unable to determine whether system 106 satisfied the policy. It should be understood that there could be more, less, or different choices for each policy.

If a policy was not found, assessor 102 enters into S.T.E.A.M. 104 what may referred to as a “finding level,” which generally indicates when the policy must/should be implemented. Examples of finding levels are listed below:

Finding level 1: the policy must be implemented immediately.

Finding level 2: the policy must be implemented by the end of assessor 102's visit.

Finding level 3: the policy must be implemented within 90 days.

Finding level 4: the policy should be implemented within 120 days.

Additionally, assessor 102 may be able to input additional details and comments about each policy into S.T.E.A.M. 104. If the system 106 subsequently implements the policy, assessor 102 may check a box in the checklist that indicates the policy has been implemented. The finding is then considered closed.

At step 310, after assessor 102 has entered all of the information from the checklist into S.T.E.A.M. 104, S.T.E.A.M. 104 generates a report that outlines the assessment's findings. S.T.E.A.M. 104 can create several different types of reports. For example, S.T.E.A.M. 104 could create a full report, which shows the results that were and were not satisfied for each control and policy. Alternatively or additionally, S.T.E.A.M. 104 could create a report that only includes controls and policies that were not satisfied. As another non-mutually-exclusive example, the S.T.E.A.M. 104 could create reports that show findings in graph or chart format.

After the database has generated the report, assessor 102 may print the report and give it to the administrator of system 106. This will enable the administrator to quickly and efficiently make all of the changes necessary for the system to be in compliance with DoD 8500.2 (which was the INFOSEC requirement used in this example).

b. Compliance with Standards and Guidelines

(i) NSA-IAM

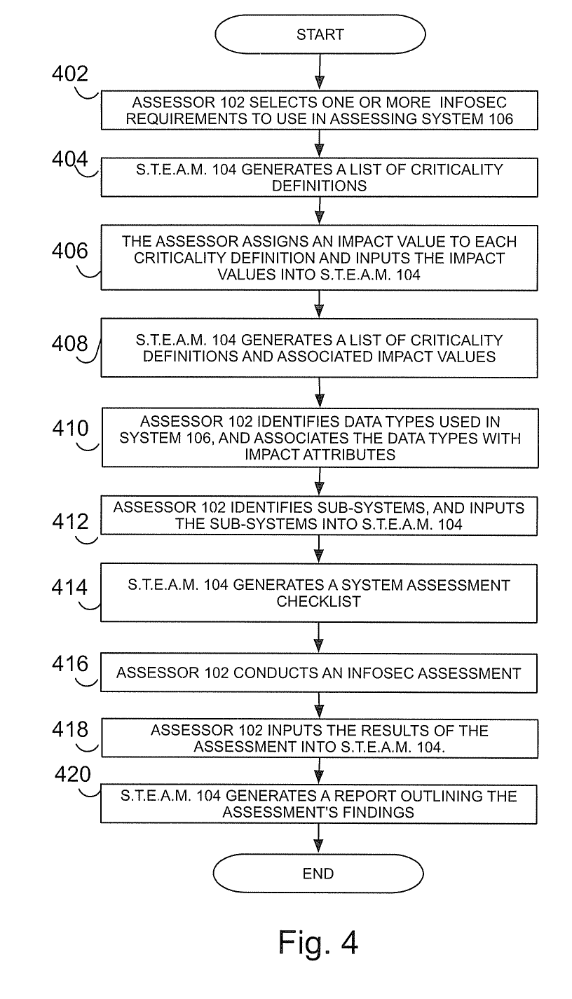

FIG. 4 is a flow chart depicting an INFOSEC assessment of a system 106. Specifically, FIG. 4 depicts an assessment according to NSA-IAM guidelines.

As shown in FIG. 4, at step 402, assessor 102 selects one or more INFOSEC requirements to use in assessing system 106. In this example, assessor 102 selects the NSA-IAM requirement. At step 404, assessor 102 instructs S.T.E.A.M. 104 to create a new survey, which causes S.T.E.A.M. 104 to obtain a list of “criticality definitions” from database 108. The criticality definition list defines events that could occur in the event that a data type stored in the system 106 is compromised. For example, the criticality definition list could include scenarios such as (1) loss of life, (2) missing corporate financial objectives, (3) recalling defective products, (4) embarrassment to the company, or (5) significant loss of revenue. Many other criticality definitions could be added to the list as well. Additionally, if there is a criticality definition specific to the system being assessed, assessor 102 can manually enter that criticality definition into S.T.E.A.M. 104, which stores the criticality definition in database 108.

At step 406, assessor 102 assigns an “impact value” (high, medium, or low) to each criticality definition, reflecting the importance of the criticality definition to system 106. Assessor 102 then instructs S.T.E.A.M. 104 to associate each criticality definition with the assigned impact value. S.T.E.A.M. 104 stores the association in database 108. As one example, assessor 102 may determine the impact value of each criticality definition through discussions with employees of the corporation being assessed.

Next, at step 408, assessor 102 instructs S.T.E.A.M. 104 to generate a list of criticality definitions, along with the criticality definitions' associated impact values. At step 410, assessor 102 identifies individual data types used in system 106. Each data type has associated with it three “impact attributes:” confidentiality, integrity, and availability (collectively “CIA”). Each impact attribute (for each data type) is assigned a “criticality value” of high, medium, or low.

Using the criticality definition list discussed above as a guide, assessor 102 chooses the criticality values of a given data type's impact attributes by determining the affect of a compromise of each impact attribute on the data type. For example, if the compromise of availability of a specific data type would (or could) result in a loss of life, and the importance of loss of life in the criticality definition list is high, then the importance of the availability impact attribute for that specific data type would be high. After assigning, for each data type, criticality values to impact attributes, assessor 102 inputs the data types, impact attributes and criticality values into S.T.E.A.M. 104, which in turn stores the information in database 108.

At step 412, assessor 102 identifies the various sub-systems used by system 106, and inputs those sub-systems into S.T.E.A.M. 104, which stores the information in database 108. Assessor 102 then instructs S.T.E.A.M. 104 to associate each data type with a particular sub-system. For example, assessor 102 may identify “accounting” as a sub-system, and “paychecks” as a data type associated with the accounting sub-system.

Sub-systems also have CIA impact attributes with respective criticality values. However, unlike criticality values associated with data types, which are determined by assessor 102, a sub-system's criticality values are determined by the CIA criticality values of the data types associated with the sub-system. In preferred embodiments, the criticality value of each of the sub-system's impact attributes is equal to the highest criticality value of any data type associated with the sub-system. For example, a sub-system associated with two data types having CIA criticality values of {C=medium, I=low, A=high}, and {C=low, I=medium, A=low}, respectively, would have CIA criticality values of {C=medium, I=medium, A=high}.

At this point, all of the baseline information has been entered into S.T.E.A.M. 104. Assessor 102 can instruct S.T.E.A.M. 104 to generate a report called an impact criticality matrix, which shows the relationship of data types to sub-systems, as well as the impact attributes for each sub-system and data type. Additionally, assessor 102 can instruct S.T.E.A.M. 104 to generate a system assessment checklist to use in assessing the system 106.

At step 414, assessor 102 instructs the S.T.E.A.M. 104 to generate a system assessment checklist, which includes controls, policies, and test cases to assist assessor 102 in assessing system 106. To create the checklist, S.T.E.A.M. 104 examines the criticality values of each sub-system's impact attributes. Based on those values, S.T.E.A.M. 104 retrieves certain policies, controls and test cases from database 108 and generates a checklist. For example, if one sub-system's confidentiality impact attribute is high, S.T.E.A.M. 104 may examine database 108 for specific controls and policies needed to protect confidentiality. S.T.E.A.M. 104 may borrow controls and policies from DoD 8500.2, or any other INFOSEC requirement such as NIST 800-53, NIST 800-53a, NIST 800-66, and HIPPA. The checklist may be ordered by control, with each control broken down into component policies.

Next, at step 416, assessor 102 uses the checklist to conduct the INFOSEC assessment. This may include printing copies of the system assessment checklist, and distributing the copies to members of assessor 102's team. At step 418. after completing the checklist and determining whether system 106 satisfied the policies and controls in the checklist, assessor 102 inputs the results into S.T.E.A.M. 104, which in turn stores the information in database 108. In this embodiment, for each policy, assessor 102 indicates whether the policy was observed, not found, not reviewed, or not applicable. If a policy was not found, assessor 102 enters into S.T.E.A.M. 104 a finding level, which indicates when the policy must/should be implemented. Examples of finding levels are listed below:

Finding level 1: the policy must be implemented immediately.

Finding level 2: the policy must be implemented by the end of assessor 102's visit.

Finding level 3: the policy must be implemented within 90 days.

Finding level 4: the policy should be implemented within 120 days.

Additionally, assessor 102 can input additional details and comments about each policy into S.T.E.A.M. 104 to store in database 108. If system 106 subsequently implements the policy, assessor 102 may check a box in the checklist that indicates the policy has been implemented. This finding is then considered closed.

At step 420, after assessor 102 has inputted all of the information from the checklist into S.T.E.A.M. 104, assessor 102 can instruct S.T.E.A.M. 104 to generate a report that outlines the assessment's findings. S.T.E.A.M. 104 may generate several different types of reports. For example, S.T.E.A.M. 104 could create a full report, which shows whether system 106 satisfied each control and policy. Additionally, S.T.E.A.M. 104 could generate a report that only includes controls and policies that were not found. As another example, S.T.E.A.M. 104 could generate reports that show findings in graph or chart format.

(ii) NSA-IEM

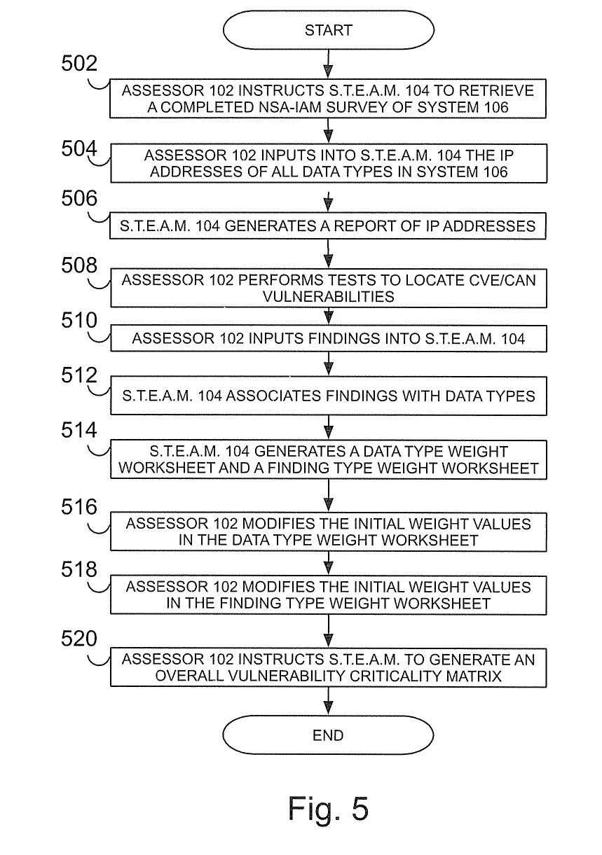

FIG. 5 is a flow chart depicting an INFOSEC evaluation of a system 106. Specifically, FIG. 5 depicts an evaluation according to NSA-IEM guidelines. In preferred embodiments, conducting an NSA-IEM survey includes (1) completing an NSA-IAM survey, (2) associating data types from the completed NSA-IAM survey with one or more IP addresses, (3) testing each IP address for vulnerabilities, (4) entering the results of the tests into S.T.E.A.M. 104, (5) generating reports of findings, (6) assigning weight values to each finding, and (7) using the weight values to determine which systems are in the greatest danger of compromise.

To begin an NSA-IEM survey, assessor 102 must retrieve a completed NSA-IAM survey. As shown in FIG. 5, at step 502, assessor 102 instructs S.T.E.A.M. 104 to retrieve a completed NSA-IAM survey of system 106 from database 108. The completed NSA-IAM survey includes the data types from the NSA-IAM assessment, which assessor 102 also uses to conduct the NSA-IEM survey. At step 504, assessor 102 inputs into S.T.E.A.M. 104 an association of system 106's IP addresses system 106's data types. This causes S.T.E.A.M. 104 to associate each data type with one or more IP addresses. At step 506, assessor instructs S.T.E.A.M. 104 to generate a report listing all IP addresses associated with each of system 106's data types. The report may list the IP addresses in order, or it may list IP addresses by data type.

Next, at step 508, assessor performs tests on machines whose IP addresses are included in the report. The tests determine whether the machine is susceptible to one or more “Common Vulnerability Exposure” (CVE/CAN) vulnerabilities. A CVE/CAN vulnerability is an INFOSEC vulnerability that has been associated with a standardized number. The well-known National Vulnerability Database (NVDB) maintains a list of all CVE/CAN vulnerabilities. For each CVE/CAN vulnerability, the NVDB describes, among other things (1) a CVE/CAN number corresponding to the vulnerability, (2) a description of the CVE/CAN vulnerability, (3) the severity of the CVE/CAN vulnerability, and (4) the impact attributes affected by the CVE/CAN vulnerability.

In preferred embodiments, assessor 102 installs tools on the machine that perform the tests. There are many commercially available tools that assessor 102 could use to determine CVE/CAN vulnerabilities on a machine. The well-known NESSUS Vulnerability Scanner is one example of such a tool.

At step 510, after testing each IP address, assessor 102 inputs all found vulnerabilities (“findings”) by CVE/CAN number into S.T.E.A.M. 104, which stores the findings in database 108. S.T.E.A.M. 104 has stored in database 108 lists of CVE/CAN vulnerabilities. Database 108 also includes, for each CVE/CAN vulnerability, (1) a corresponding CVE/CAN number, (2) a description of the CVE/CAN vulnerability, (3) the severity level of the CVE/CAN vulnerability, and (4) a list of which impact attribute, or attributes affected by the CVE/CAN vulnerability.

After receiving the findings from assessor 102, S.T.E.A.M. 104 associates additional CVE/CAN information with each finding. As noted above, the information includes (1) a description of the finding's CVE/CAN number, (2) the finding's severity level (i.e. low, medium, or high), and (3) a list of one or more impact attributes (i.e. confidentiality, integrity, or availability) that would be affected if the finding were exploited.

If assessor 102 wishes to input a finding that does not have a CVE/CAN number (i.e., the threat is brand new), assessor 102 may (1) create a name for the finding, (2) input the severity of the finding, and (3) specify one or more impact attributes that would be affected if the finding were exploited.

Additionally, assessor 102 may input into S.T.E.A.M. 104, for each finding, a finding level, which indicates when the policy must/should be implemented. Also, assessor 102 may input into S.T.E.A.M. 104 additional details and comments about each finding.

It should be understood that CVE/CAN numbers may be entered manually by assessor 102, or may be imported from assessor 102's vulnerability detection tool. For example, if assessor 102 uses the well-known NESSUS Vulnerability Scanner to obtain a list of CVE/CAN vulnerabilities, assessor 102 could import the findings directly from the NESSUS Vulnerability Scanner into S.T.E.A.M. 104.

Next, at step 512, assessor 102 inputs into S.T.E.A.M. 104 an association between the findings and the specific IP address (or addresses) affected by the finding. This in turn causes S.T.E.A.M. 104 to associate findings with data types. If assessor 102 manually entered the findings into S.T.E.A.M. 104, assessor 102 must manually enter the association between the IP addresses and findings. However, if assessor 102 imported the findings directly from a vulnerability detection tool, S.T.E.A.M. 104 will automatically associate the findings with IP addresses. It should be understood that steps 510 and 512 may be performed simultaneously. For example, Assessor 102 may input a CVE/CAN number into S.T.E.A.M. 104, and then associate IP addresses with that CVE/CAN number before inputting another CVE/CAN number into S.T.E.A.M. 104.

At this point, S.T.E.A.M. 104 has associated all findings with data types and IP addresses. At step 514, assessor 102 instructs S.T.E.A.M. 104 to generate two reports for assessor 102 to use to assign weight values to each data type and finding. The weight values provide additional depth to the IEM-Assessment by (1) allowing assessor 102 to indicate how severe he or she considers each finding, and (2) allowing the administrators of system 106 to specify the importance of system 102's data types and corresponding impact attributes.

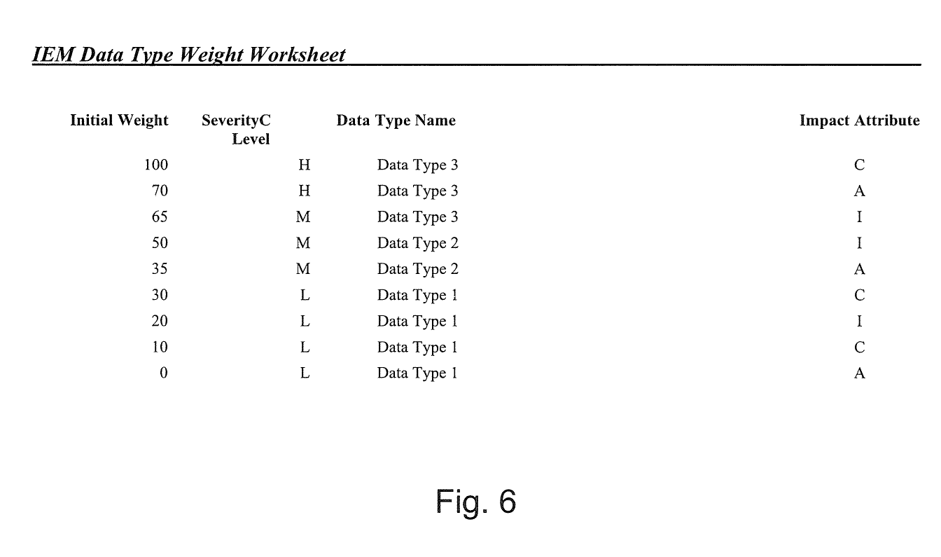

The first report generated by S.T.E.A.M. 104 is known as a “data type weight worksheet,” and lists all data types that have been associated with a finding. An example of a data type weight worksheet is shown in FIG. 6. As shown in FIG. 6, each entry in the data type weight worksheet lists (1) the data type, (2) one impact attribute affected by the finding, (3) the severity level of the finding, and (4) an initial weight value assigned to the vulnerability. If a data type has additional impact attributes affected by the finding, the data type will appear in an additional entry in the data type weight worksheet, along with an additional impact attribute.

The initial weight value in the data type weight worksheet is a number between 0 and 100 that reflects the severity of the vulnerability. S.T.E.A.M. 104 calculates the initial weight values as follows: vulnerabilities having (1) a low severity level are assigned an initial weight between 0 and 30, (2) a medium severity level are assigned an initial weight of 35-65, and (3) a high severity level are assigned with an initial weight of 70-100. S.T.E.A.M. 104 evenly distributes the initial weight values for each severity level. For example, if there are four vulnerabilities associated with a “low” severity level, S.T.E.A.M. 104 will assign the vulnerabilities with initial weight values of 0, 10, 20, and 30.

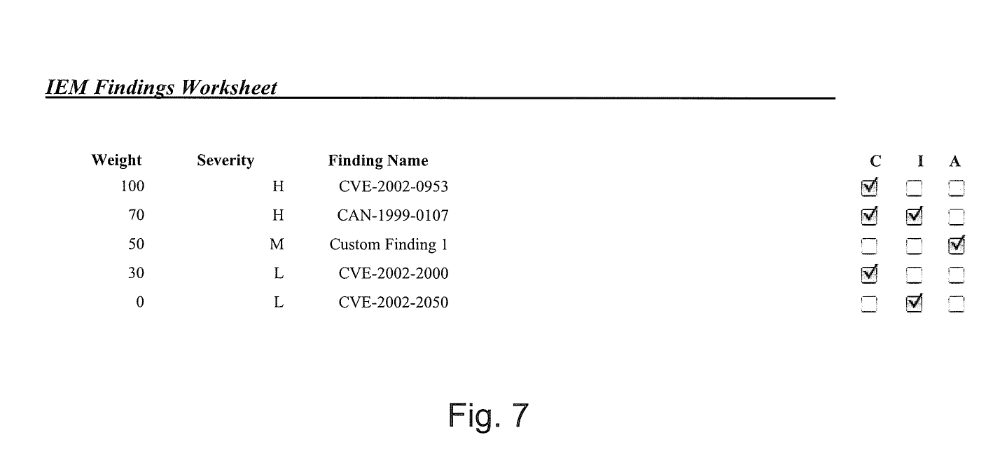

The second report generated by S.T.E.A.M. 104 is known as a “finding type weight worksheet,” and lists all of the findings found in system 106. An example of the finding type weight worksheet is shown in FIG. 7. As shown in FIG. 7, for each finding, the finding type weight worksheet lists (1) the finding's associated CVE/CAN number (or manually entered description), (2) the impact attribute (or attributes) affected by the finding, (3) the severity level of the finding, and (4) an initial weight value assigned to the finding. S.T.E.A.M. 104 calculates the initial weight value in the finding type weight worksheet the same way as in the first report.

At step 516, assessor 102 modifies the initial weight values assigned to each data type in the data type weight worksheet, and inputs the modified values into S.T.E.A.M. 104. Assessor 102 may determine the modified weight values (also known as “data type criticality weights”) by discussing the importance of each data type and impact attribute with the administrator (and other people with knowledge) of system 106. The higher the value of a data type's criticality weight, the more important the data type is to system 106.

At step 518, assessor 102 modifies the initial weight values assigned to the findings in the finding type weight worksheet and inputs the modified values into S.T.E.A.M. 104. Generally, assessor 102 determines the value of the modified weight variable (also known as the “technical finding weight”) using assessor 102's (and assessor 102's team's) knowledge and experience. A higher value of a finding's technical finding weight indicates that the finding is more severe.

Next, at step 520, assessor 102 instructs S.T.E.A.M. to generate what is known as an “overall vulnerability criticality matrix.” (OVCM). An OVCM is a graphical representation of a system's vulnerabilities, and allows the administrator of system 106 to quickly ascertain system 106's most vulnerable data types. Additionally, S.T.E.A.M. 104 uses the OVCM to calculate a “quality score,” that assessor 102 may use to compare the security of system 106 with other systems of a similar nature that have been or will be assessed.

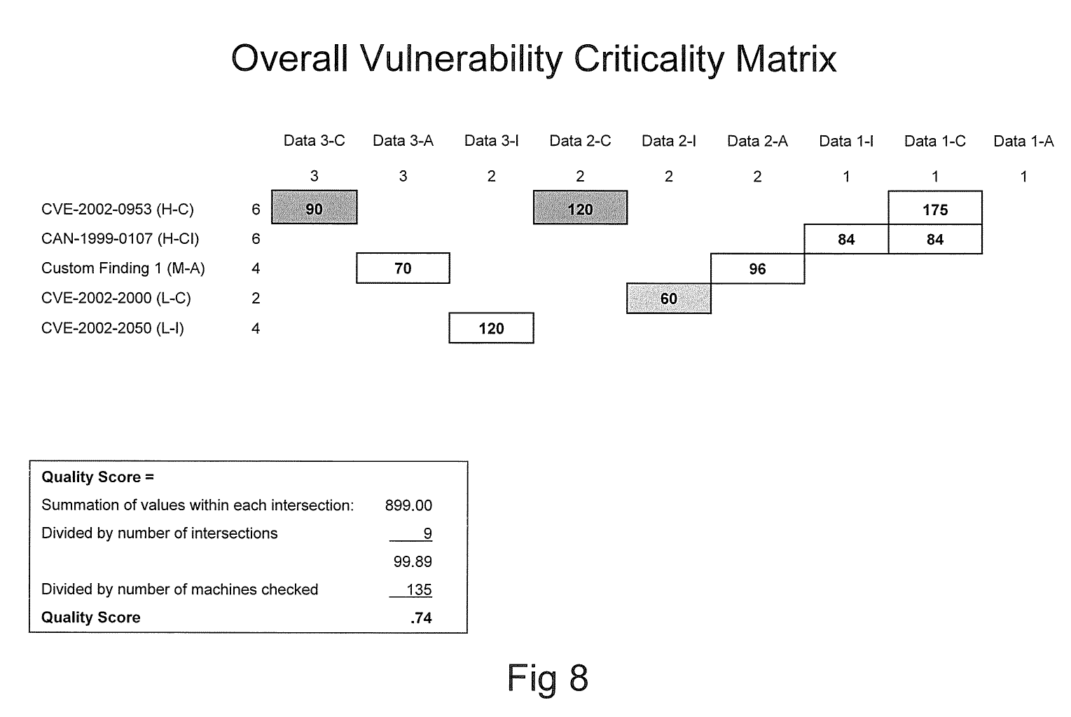

An example of an OVCM is shown in FIG. 8. FIG. 8 uses the same data types included in FIG. 6, and the same findings as FIG. 7. Further, FIG. 8 assumes that S.T.E.A.M. 104 has associated the data types and findings as follows:

| | | | | | Number of Devices |
|---|---|---|---|---|---|
| | | | | Associated | (IP addresses) |
| Finding Name | C | I | A | Data Types | Affected by the Finding |
| CVE-2002-0953 | X | | | 1, 2, 3 | Data Type 1: 25 |
| | | | | | Data Type 2: 15 |
| | | | | | Data Type 3: 10 |
| CAN-1999-0107 | X | X | | 1 | Data Type 1: 12 |
| Custom Finding 1 | | | X | 2, 3 | Data Type 2: 16 |
| | | | | | Data Type 3: 10 |
| CVE-2002-2000 | X | | | 2 | Data Type 2: 15 |
| CVE-2002-2050 | | X | | 3 | Data Type 3: 20 |

As shown in FIG. 8, the OVCM displays information in (x, y) matrix format. The x-axis corresponds to ordered pairs of data types and impact attributes listed in descending order of data type criticality weight. S.T.E.A.M. 104 assigns an “OVCM data type value”, from 1 to 3, to each ordered pair. If the ordered pair was given a data type criticality weight between 70-100, S.T.E.A.M. 104 will assign the ordered pair an OVCM data type value of 3. If the ordered pair was given a data type criticality weight between 35-69, S.T.E.A.M. will assign the ordered pair an OVCM data type value of 2. Finally, if the ordered pair was given a data type criticality weight between 0-34, S.T.E.A.M. 104 will assign the ordered pair an OVCM data type value of 1.

The y-axis on the OVCM corresponds to a list of findings ranked in descending order of technical finding weight. S.T.E.A.M. 104 assigns an “OVCM technical finding value” of 2, 4, or 6, to each finding. If the finding was given a technical finding weight between 70-100, S.T.E.A.M. 104 will assign the finding an OVCM technical finding value of 6. If the finding was given a technical finding weight between 35-69, S.T.E.A.M. 104 will assign the finding an OVCM technical finding value of 4. Lastly, if the finding was given a technical finding weight between 0-34, S.T.E.A.M. 104 will assign the finding an OVCM technical finding value of 2.

Further, as shown in FIG. 8, wherever a finding intersects with an associated data type and impact attribute, S.T.E.A.M. 104 assigns the intersection with a score. The score is equal to [(OVCM technical finding value+OVCM data type value)* the number of unique devices affected by the finding]. This score assists assessor 102 and the administrator of system 106 to quickly identify problem areas associated with system 106.

Additionally, different intersections within the OVCM may be associated with different colors, reflecting the severity of the finding to the data type and corresponding impact attribute. For example, the range of scores may be divided into sevenths. Scores falling within the upper two-sevenths may be color coded red. Scores that fall in the lower three-sevenths may be color coded green. Finally, scores that fall within the middle two-sevenths may be color coded yellow. Color coding each intersection further allows assessor 102 and the administrator of system 106 to quickly identify problem areas associated with system 106.

Finally, S.T.E.A.M. 104 calculates a quality score for system 106. To determine the quality score, S.T.E.A.M. 104 first sums the values of each intersection. S.T.E.A.M. 104 then divides the sum by the total number of intersections in the OVCM. Next, S.T.E.A.M. 104 divides that number by the number of machines assessed in system 106. As shown in FIG. 8, the quality score is equal to 0.74. Assessor 102 can use the quality score to compare the security of system 106 to the security of other systems.

### 4. CONCLUSION

Various embodiments of the present methods and systems have been described above. Those skilled in the art will understand, however, that changes and modifications may be made to this embodiment without departing from the true scope and spirit of the present invention, which is defined by the claims.

1. A method for performing an information security assessment of a computer system, comprising:
encoding at least one information security requirement in a database, wherein each encoded information security requirement is associated with at least one encoded policy;
receiving a first input, wherein the first input requests at least one encoded information security requirement, wherein performing the information security assessment comprises determining whether the computer system complies with the requested encoded information security requirement;
in response to the first input, generating a first checklist comprising at least one policy associated with the at least one information security requirement;
receiving a second input, wherein the second input indicates whether the computer system satisfied the at least one policy; and
in response to receiving the second input, generating a second report, wherein the second report comprises a description as to whether the computer system satisfied the at least one policy.

2. The method of claim 1, wherein each encoded information security requirement is further associated with at least one encoded control.

3. The method of claim 1, wherein the encoded information security requirement corresponds to the Department of Defense Instruction 8500.2.

4. The method of claim 1, wherein the second report further comprises a listing of each policy that was not satisfied.

5. The method of claim 2, wherein the second report further comprises listing each policy and each control that were not satisfied.

6. A method for performing an information security assessment of a computer system, comprising:
generating a list, wherein the list comprises at least one criticality definition;
receiving a first input, wherein the first input associates a value to each of the at least one criticality definition;
generating a first report, wherein the first report comprises a description of the at least one criticality definition and associated value;
receiving a second input, wherein the second input (i) defines at least one data type and (ii) associates impact attributes with the at least one data type, each impact attribute being assigned with a criticality value;
receiving a third input, wherein the third input associates each of the at least one data type with at least one sub-system;
associating the at least one criticality definition and associated value with at least one encoded information security requirement, wherein the at least one encoded information security requirement is associated with at least one encoded policy;
generating a checklist comprising the at least one encoded policy;
receiving a fourth input, wherein the fourth input comprises an indication of whether the computer system satisfied the at least one encoded policy; and
generating a second report, wherein the second report comprises a description as to whether the computer system satisfied the at least one policy.

7. The method of claim 6, wherein the fourth input further comprises a finding level.

8. The method of claim 7, wherein the fourth input further comprises comments regarding the at least one policy.

9. The method of claim 6, wherein the checklist further comprises at least one control.

10. The method of claim 6, further comprising:
generating an impact criticality matrix.

11. A method for performing an information security evaluation of a computer system, comprising:
providing encoded information security vulnerabilities, wherein each encoded vulnerability is associated with (i) a CVE/CAN number, (ii) a description, (iii) a severity level, and (iv) a list of impact attributes;
receiving a completed information security assessment of a computer system, wherein the completed information security assessment includes a set of data types.
receiving a first input, wherein the first input associates a set of IP addresses to a set of data types;
receiving a second input, wherein the second input associates a set of CVE/CAN numbers to the set of IP addresses;
using the first and second inputs to associate a set of CVE/CAN numbers to a set of data types, and produce a first report of data types associated with the set of CVE/CAN numbers;
receiving a third input, wherein the third input comprises a data type criticality weight for each data type in the first report;
receiving a fourth input, wherein the fourth input comprises a technical finding weight for each CVE/CAN number of the second input; and
using the third and fourth inputs to generate an overall vulnerability criticality matrix.

12. The method of claim 11 further comprising presenting the set of data types.

13. The method of claim 11, further comprising:
using the second input to produce a second report CVE/CAN numbers.

14. The method of claim 11, wherein the overall vulnerability criticality matrix comprises an x-axis, wherein each entry along the x-axis corresponds to ordered pairs of data types and impact attributes.

15. The method of claim 14, wherein entries along the x-axis are listed in descending order of data type criticality weight.

16. The method of claim 14, wherein the overall vulnerability criticality matrix further comprises a y-axis, wherein each entry along the y-axis corresponds to a CVE/CAN vulnerability listed in the second report.

17. The method of claim 16, wherein entries along the y-axis are listed in descending order of technical finding weight.

18. The method of claim 11, further comprising:
receiving a fifth input, wherein the fifth input defines an information security vulnerability that has not been associated with a CVE/CAN number.

19. The method of claim 15, wherein the fifth input assigns to the information security vulnerability that has not been associated with a CVE/CAN number (i) a description, (ii) a severity level, and (iii) at least one impact attribute affected by the information security vulnerability.

20. The method of claim 1, wherein the encoded information security requirement corresponds to the Health Insurance Portability and Accountability Act.
